(19) United States
(12) Patent Application Publication
(10) Pub. No.: US 2002/0012721 A1
(43) Pub. Date: Jan. 31, 2002

(54) Cooked cereal ingredient-containing products fortified with non-ferric edta and insoluble iron compositions and methods for use

(76) Inventors: S. Sungsoo Cho, Battle Creek, MI (US); Louis C. Morel, Battle Creek, MI (US); Luis A. Mejia, The Woodlands, TX (US); Priscilla Samuel-Fernando, New Berlin, WI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 09/728,853

(22) Filed: Dec. 1, 2000

Related U.S. Application Data
(63) Continuation-in-part of application No. 09/126,982, filed on Jul. 31, 1998, now abandoned.

(51) Int. Cl. A23L 1/304; A23L 1/164; A23L 1/168

(52) U.S. Cl. 426/72; 426/618; 426/619; 426/620

(57) ABSTRACT

A cooked cereal-ingredient containing food product is modified to improve the bioavailability of iron in the product. The product includes a non-ferric EDTA source and an insoluble iron source. The combination of the non-ferric EDTA source and the insoluble iron source enhance the bioavailability of the insoluble iron source.

This application claims priority to U.S. patent application Ser. No. 09/126,982 filed Jul. 31, 1998.

### BACKGROUND OF THE INVENTION

Approximately one-fifth of the world's population suffers from some level of nutritional iron deficiency. Young children and women of childbearing age are the most adversely affected by anemia and other iron deficiency related conditions. Anemia during pregnancy can lead to risk of premature labor, (Lieberman et al., Am. J. Obstet. Gyn. 159:107-114) and an increased perinatal morbidity and mortality, (Bothwell et al. In Iron Metabolism in Man, 1979). Children's development may also be impaired, subsequently having an effect on their performance in school. Iron deficiency can also adversely affect productivity as seen among laborers (Edgerton et al., Brit. Med. J. 2:1546-9, 1979).

Heme iron, which is derived primarily from hemoglobin and myoglobin in dietary meat, is transferred as an intact porphyrin complex to intestinal cells during consumption and absorption, where the heme oxygenase enzyme rapidly releases the iron. It is combined with other iron taken up by the intestinal cells before the regulated transfer of the iron to the blood stream occurs. This form of iron is readily absorbed and is generally not affected by the other contents of the meal. The non-heme dietary iron has a heterogenous origin, being derived from vegetable foods and inorganic forms of iron, and can be used to fortify foods by increasing the level of iron present.

Non-heme iron, which is derived from plant and fortified foods is not as well absorbed as heme (meat) iron. Furthermore, beverages such as coffee and tea consumed at mealtime and other factors can contribute to poor absorption of non-heme iron.

The addition of ascorbic acid or vitamin C to shelf stable cereal based products can enhance iron absorption in the diet, generally without affecting consumer acceptability. However, ascorbic acid fortification is expensive and when exposed to oxygen and moisture ascorbic acid can be unstable during storage. In cases where food preparation involves baking, prolonged boiling or reheating, ascorbic acid is unstable and is partially degraded.

The most efficient and cost-effective way of preventing and treating iron deficiency is to fortify food products with a form of iron that is easily absorbed. While cost is not necessarily a controlling factor in whether an affluent consumer would purchase an iron fortified product, among the poor and in less-well developed countries cost often becomes the controlling factor. Currently used iron fortificants, such as ferrous sulfate, have adequate bioavailability, however they adversely affect the organoleptic properties of cooked cereal ingredient-containing, storage stable food products, (hereinafter referred to as storage stable cereal products).

Ferrous sulfate (FeSO₄) has proven to be ineffective when included in foods high in iron inhibitors such as phytates and tannins. Further, Ferrous sulfate does not exhibit the stability required for use in dried, storage stable cereal products that have extended shelf lives. As ferrous sulfate chemically degrades, it adversely affects the organoleptic properties of the cereal product such as, taste and brightness. As ferrous sulfate degrades, it can cause the cereal product to exhibit a metallic taste. Further, ferrous sulfate can discolor the cereal pieces as it degrades giving the appearance that the cereal has spoiled.

Ferric ethylenediaminetetraacetic acid (EDTA) has been suggested as a suitable alternative, to ferrous sulfate given its unique properties that make the iron available for absorption despite the presence of inhibitory factors in the food and meal. Ferric EDTA salts, such as NaFe(III)EDTA have proven to be chemically stable and suitable as a fortificant in foods that may have long term storage requirements, such as dried cereals. However, ferric EDTA salts are costly they are not readily available.

Insoluble forms of iron are known to be chemically stable when combined with typical cereal ingredients. Insoluble irons such as reduced iron and iron phosphate (FePO₄), are less costly than soluble ferric compounds such as FeSO₄ and NaFe(III)EDTA. However, alone, insoluble forms of iron do not include the bioavailability properties of these soluble ferric compounds. It would be desirable to produce a dried cereal having an iron fortificant that provides the bioavailability of FeSO₄ and NaFe(III)EDTA and yet includes the low cost and stability of the insoluble forms of iron.

### SUMMARY OF THE INVENTION AND ADVANTAGES

The present invention is a cooked cereal-ingredient containing food product modified to improve the bioavailability of iron. A non-ferric EDTA salt, such as, for example, Na₂EDTA, tri-sodium EDTA, tetra-sodium EDTA, potassium EDTA, and calcium EDTA is blended into a cereal dough along with an insoluble iron source. The combination of the non-ferric EDTA and the insoluble iron source in cereal has proven to significantly improve the level of bioavailability of iron. The non-ferric EDTA's are much less costly and more available than the ferric EDTA's.

Unlike FeSO₄ and NaFe(III)EDTA, insoluble iron is not chemically reactive with any of the ingredients used to form dried, storage stable cereal products. Therefore, insoluble iron will not adversely affect the shelf life of the cereal product as other iron compounds have the propensity to do. Further, reduced iron is a less expensive source for iron than FeSO₄ and NaFe(III)EDTA. By reducing the cost of providing iron in a bioavailable form, the feasibility of providing iron enriched food products to developing countries, whose populace is most in need of this dietary supplement, is increased.

### DETAILED DESCRIPTION OF THE PREFERRED EMBODIMENT

Adding an iron source to prepared food products, such as, for example dried, storage stable cereal products is widely known in the art of food science. The inclusion of an iron source in a storage stable cereal product presents unique issues involving the stability of the cereal.

The present invention is a cooked cereal ingredient containing storage stable product modified to improve the bioavailability of iron. The storage stable cereal products of this invention may be prepared from dried cereal comprising of wheat, rice, oat, corn, barley, rye, millet, sorghum, amaranth seed and mixtures thereof. Furthermore, other ingredients, including but not limited to, sugars, salts, spices, flavorings, fruits, nuts, vitamins and minerals, which may add to the flavor or nutritional aspects of the final product, may be added to the storage stable cereal product without departing from the spirit and scope of the invention. In addition, high fiber sources, such as psyllium as disclosed in U.S. Pat. No. 5,227,248 and PCT/US94/10290 incorporated herein by reference in their entirety, may also be included in the storage stable cereal products.

The storage stable cereal product includes not only ready-to-eat breakfast cereals, such as Corn Flakes® and Rice Krispies®, but also includes other food products, such as snack bars, including NurtriGrain® bars and Rice Krispies Treats™, toaster pastries, such as PopTarts®, and pastry products, which are all produced using cooked cereal ingredients. These storage stable cereal products can be fortified in the same manner with the combination of the insoluble iron source and the non-ferric EDTA source as described herein.

The storage stable cereal product is derived from a cereal dough that is blended using the ingredients listed above as is known in the art. The cereal dough is mixed with a non-ferric EDTA source and an insoluble iron source, the benefits of which will be explained further below. The dough is formed into a plurality of dough pieces, which are cooked to form cereal pieces. The cereal pieces are dried to a moisture content of less than about 12% to enhance the storage stability of the cereal product prior to packaging for consumer sales. Alternatively, the insoluble iron source and the non-ferric EDTA can be mixed separately from the dough and subsequently sprayed onto the formed cereal pieces.

The non- ferric EDTA comprises preferably Na₂EDTA, tri-sodium EDTA, tetra-sodium EDTA, potassium EDTA, and calcium EDTA. However, other non-ferric EDTA salts are known to be equally effective.

The use of insoluble iron sources overcomes many of the difficulties derived from the use of the prior art iron sources such as, for example, FeSO₄, ferric EDTA, and sodium-ferric EDTA. Ferrous sulfate, which is the prepared food industry standard iron fortificant, has proven to be ineffective when included in foods high in iron inhibitors such as phytates and tannins. Further, Ferrous sulfate does not exhibit the stability required for use in dried, storage stable cereal products that have extended shelf lives. As ferrous sulfate degrades, it adversely affects the organoleptic properties of the cereal product such as, taste and brightness. Degrading ferrous sulfate causes the cereal product to exhibit a metallic taste. Further, ferrous sulfate can discolor the cereal pieces as it degrades giving the appearance that the cereal has spoiled. Insoluble iron exhibits none of these problems as it is non-reactive with the cereal ingredients listed above.

Reduced iron is a form of insoluble iron derived from hydrogen reduced metallic iron powder. The iron powder, in its elemental state, is insoluble in water and non-reactive with the ingredients typically included in food products. Less than about 5% of the reduced iron has a particle size greater than 75 microns. At least about 95% of the reduced iron has a particle size of greater than 45 microns. To meet dietary needs, preferably, approximately 1.5 to 18 mg of reduced iron is included in a 30 g serving of a cereal product. Preferably, between 2.5 and 8.5 mg of reduced iron is included in a 30 g serving of a cereal product. An alternative source of insoluble iron is iron phosphate (FePO₄), which has proven to have equivalent durability and nearly equivalent bio-absorptive properties when combined with an EDTA salt as reduced iron. Iron phosphate is also mixed with a 30 g serving to achieve an iron content of between 1.5 to 18 mg and preferably between 2.5 and 8.5 mg.

Sodium EDTA's are safe for use in food products. (Iron EDTA for Food Fortification: A Report of the International Nutritional ANEMIA Consultative Group, The Nutrition Foundation, Inc., Bates et al. Eds (1993)). Disodium EDTA, a white, water soluble chelating agent, is deemed to be safe for use in aqueous multi-vitamins, a variety of canned foods including peas, beans, pie fillings, salad dressings, frozen potatoes, mayonnaise, and dried bananas used in ready-to-eat breakfast cereals. Disodium EDTA is used to promote color retention and as a preservative. It is also used as a cure accelerator in cooked sausages. Additionally, calcium disodium EDTA is used to promote color, flavor, and texture retention in pickled cucumbers and cabbage, in canned foods, such as carbonated soft drinks, white potatoes, clams, mushrooms, beans, and in dry processed foods, such as pinto beans and lima beans. It is also used as a preservative in foods, such as salad dressings, oleomargarine, and potato salad. In addition, calcium disodium EDTA is used to retard struvite formation in seafood, such as canned crabmeat and shrimp, and to promote stability of color, flavor and/or clarity of distilled alcoholic beverages. However, prior to this invention, food products were not fortified with EDTA salts and an insoluble iron source such as reduced iron or iron phosphate to enhance iron bioavailability.

The storage stable cereal product is prepared with the insoluble iron source and EDTA combination by either incorporating it into the cereal dough mix prior to cooking or by spraying an insoluble iron/EDTA solution onto the finished storage stable cereal product. The combination of the insoluble iron source and the EDTA source results in unexpectedly enhanced iron bioavailability over a like product fortified with an insoluble iron alone. Insoluble iron does not adversely affect taste and maintains excellent brightness characteristics and oxidative stability, as well as having a significant reduction in cost over a like product fortified with a ferric EDTA or FeSO₄. These unexpected properties of the insoluble iron/EDTA salt fortified storage stable cereal product described above have not been established prior to this application.

An experiment was conducted to validate the effectiveness of combining reduced iron with a non-ferric EDTA salt. Six sources of iron were compared in a study conducted on women. The sources tested are listed in Table 1:

TABLE 1

| | % Daily | |
|---|---|---|
| Iron Source | Value Iron | EDTA:Iron |
| (a) FeSO₄ | 25% | N/A |
| (b) FeSO₄ | 50% | N/A |
| (c) FeSO₄ + FeEDTA | 25% | 1:4 |
| (d) Reduced Fe + FeEDTA | 25% | 1:3 |
| (e) Reduced Fe + FeEDTA | 25% | 1:2.4 |
| (f) Reduced Fe + Na₂EDTA | 25% | 1:2.4 |

The study was performed using a serving of corn flakes, approximately 30 g, with the addition of 150 ml lactose free UHT-treated 2% fat cow's milk. The percentage of iron absorbed by the test subjects was determined from radioactivity present in the circulating erythrocytes. Labeled ⁵⁹FeCl₃ was used as a tracer in the reference dose of ferrous ascorbate and in the treatments containing FeSO₄. Labeled ⁵⁵FeCl₃ was used as a tracer in the treatments containing elemental reduced iron. The percentage of iron absorbed by the test subjects was normalized by the reference dose of ferrous ascorbate.

The normalized percent absorption of each of the six sources is listed in Table 2:

TABLE 2

| Source | Normalized Absorption |
|---|---|
| (a) FeSO₄ | 11.4 |
| (b) FeSO₄ | 6.9 |
| (c) FeSO₄ + FeEDTA | 8.2 |
| (d) Reduced Fe + FeEDTA | 9.8 |
| (e) Reduced Fe + FeEDTA | 11.1 |
| (f) Reduced Fe + Na₂EDTA | 11.0 |

The test results unexpectedly indicate that the combination of reduced iron and Na₂EDTA at a ratio of 1:2.4 yield statistically similar absorptive properties as FeSO₄ and reduced iron and FeEDTA. Further, these results indicate that reduced iron is a viable alternative to FeSO₄ and Ferric EDTA by providing equally efficient iron absorption as these compounds. Given the known benefits that reduced iron exhibits over FeSO₄ when included in a dried cereal product, reduced iron in combination with non-ferric EDTA is preferable to FeSO₄ or to reduced iron and Ferric EDTA.

An additional study was performed to determine the bioavailability of iron phosphate when combined with Na₂EDTA. The relative iron bioavailability of the various iron containing compositions in a ready-to-eat cereal product was assayed using a widely accepted method, commonly referred to as the rat hemoglobin repletion method, (modified AOAC method for assessment of relative iron bioavailability), see Williams, S. ed. Official methods of analysis of the Association of Official Analytical Chemists, 14th ed. Arlington, Va. AOAC, 1984; Fritz, J. C. et al., Collaborative Study of rat hemoglobin repletion test for bioavailability of iron, AOAC 1974, 57:513-517. Relative bioavailability of the various iron:EDTA composition was carried out in a series of separate experiments. In each of these experiments, ferrous sulfate was used as the standard or control compound.

Sprague Dawley rats, individually housed in temperature and light controlled units, were fed an iron deficient diet obtained from Harland Tekland Laboratories for 24 days. After this iron depletion phase, the rats were weighed and blood was drawn to test for baseline hemoglobin concentrations. These anemic animals, with hemoglobin levels between 2.9 to 4.1 g/l, were then randomly assigned to the control and test groups. Ferrous sulfate, iron phosphate, and iron phosphate with Na₂EDTA were separately added to the test diets to achieve concentrations of 6 and 18 and 24 mg iron/kg diet. These diets were then fed to groups of ten animals, ad libitum, for 14 days. Iron levels in the diets, were verified by atomic absorption spectrometry (Blin et al., J. Assoc. Off. Anal. Chem. 1977, 60:1170-1174). After the 14-day test period, hemoglobin concentrations were determined for all animals.

The iron bioavailability of each iron source, assayed relative to ferrous sulfate, was calculated using the slope ratio procedure by comparing the gain in hemoglobin concentration with the iron concentration in the diet (Finney, D. J., Statistical methods in biological assay.2nd ed. 1964; Amine et L., Biological assessment of available iron in food products, J. Agric. Food Chem. 1974, 22:470-476). Intercept and slope estimates were obtained for the rats fed diets that were not fortified (negative controls) and rats fed each test diet using the ordinary least square's method. All test diet intercepts were compared to the negative control diets to validate the fitting of a common intercept. Comparison of the slopes of the test diets with the standard (ferrous sulfate) diet was performed after fitting the data through a common intercept. Bioavailability was defined as the ratio of the slope of each diet relative to the slope of the ferrous sulfate diet. The statistical program SAS V.608 was used. The percent absorption relative to FeSO₄ was calculated from the slopes determined from each experiment.

Rats were fed a purified rat diet/Corn Flakes® fortified increasing molar ratios of Na₂EDTA:reduced iron to determine an optimum ratio of Na₂EDTA to reduced iron. The test results as indicated in Table 3 show the optimum molar ration is 1:1 of Na₂EDTA:reduced iron and greater amounts Na₂EDTA.

TABLE 3

| Molor Ratio | Relative |
|---|---|
| Na₂EDTA:reduced iron | Absorption* |
| 100% Reduced Iron | 0.42 (d) |
| 1:3 | 0.41 (d) |
| 1:2 | 0.51 (c) |
| 1:1.3 | 0.47 (cd) |
| 1:1 | 0.68 (b) |
| 1.5:1 | 0.68 (b) |

*Estimates with the same letter do not differ (P < .10)

The slope of the absorption plotted against time was calculated to distinguish the absorption effectiveness of each of the molar ratios. As the table indicates, an improvement in absorption begins to be realized a molar ratio of Na₂EDTA:reduced iron of 1:2. The most efficient iron absorption was realized at a molar ratio of Na₂EDTA:reduced iron of 1:1 and greater.

An additional test was conducted feeding rats a purified rat diet/Corn Flakes® fortified with iron phosphate either alone or in combination with Na₂EDTA or mixtures of both. The iron bioavailability in the iron phosphate fortified diets were compared to the iron bioavailability in diets fortified with FeSO₄. As described above the bioavailability was determined by assaying the relative change in hemoglobin in rats fed with the various fortified diets with the recommended daily allowance for humans of iron content (RDA).

Three test diets were evaluated:

A) 45% RDA FeSO₄

B) 45% RDA FePO₄

C) 45% RDA FePO₄—Na₂EDTA (1:1 Fe:EDTA)

All products were fed at levels equivalent to 6, 12, 24 and 48 mg Fe/kg diet. The addition of di-sodium EDTA greatly improved bioavailability of the iron phosphate, approximately doubling bioavailability, and approached the bioavailability obtained with the reference FeSO₄. The results are shown in Table 4:

TABLE 4

| | | | | Percent |
|---|---|---|---|---|
| | | | | Absorption |
| | | Intercept | | Relative to |
| Iron Source | Intercept | Differences | Slope* | FeSO₄ |
| A) FeSO₄ | −2.10 | none | 0.30 (c) | 100% |
| B) FePO₄ | −1.82 | none | 0.10 (a) | 33% |
| C) FePO_{4 - Na}₂EDTA | −2.16 | none | 0.22 (b) | 66% |
| (1:1 Fe:EDTA) | | | | |

*Estimates with the same letter do not differ (P < .10)

The addition of Na₂EDTA to Corn Flakes® fortified with iron phosphate greatly improved the bioavailability of iron. The relative bioavailability was roughly twice that of iron phosphate without Na₂ EDTA.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described.

What is claimed is:

1. A cooked cereal-ingredient containing food product with enhanced bioavailability comprising:
a dried cereal ingredient;
a non-ferric EDTA source; and
an insoluble iron source wherein the combination of said non-ferric EDTA source and said insoluble iron source enhances a bioavailability of said insoluble iron source.

2. A cooked cereal-ingredient containing food product as recited in claim 1 wherein said non-ferric EDTA source comprises Na₂EDTA, tri-sodium EDTA, tetra-sodium EDTA, potassium EDTA, calcium EDTA or mixtures thereof.

3. A cooked cereal-ingredient containing food product as recited in claim 1 wherein said insoluble iron source comprises reduced iron, iron phosphate, or mixtures thereof.

4. A cooked cereal-ingredient containing food product as recited in claim 3 wherein less than 5% of said reduced iron has a particle size greater than 75 microns.

5. A cooked cereal-ingredient containing food product as recited in claim 4 wherein at least 95% of said reduced iron has a particle size greater than 45 microns.

6. A cooked cereal-ingredient containing food product as recited in claim 3 wherein a range of molar ratio of non-ferric EDTA to reduced iron is at least 1:2.

7. A cooked cereal-ingredient containing food product as recited in claim 6 including a molar ratio of non-ferric EDTA to reduced iron is about 1:2.4.

8. A cooked cereal-ingredient containing food product as recited in claim 3 wherein said non-ferric EDTA and said iron phosphate are mixed at a molar ratio at least 1:1.

9. A cooked cereal-ingredient food containing product as recited in claim 1 wherein said dried cereal ingredient has a moisture content of less than or equal to 12%.

10. A cooked cereal-ingredient containing food product as recited in claim 3 comprising from about 1.5 to about 18 mg of total insoluble iron per 30 g of said cooked cereal-ingredient containing food product.

11. A cooked cereal-ingredient containing food product as recited in claim 10 comprising between about 2.5 and 8.5 mg of total insoluble iron per 30 g serving of said cooked cereal-ingredient containing food product.

12. A cooked cereal-ingredient containing food product as recited in claim 1 wherein said insoluble iron source is insoluble in water.

13. A cooked cereal-ingredient containing food product as recited in claim 1 wherein said cereal ingredient comprises wheat, rice, oat, corn, barley, rye, millet, amaranth seed, and mixtures thereof.

14. A cooked cereal-ingredient containing food product as recited in claim 1 further comprising sugars, salts, spices, flavorings, fruits, nuts, vitamins and minerals, and mixtures thereof.

15. A cooked cereal-ingredient containing food product as recited in claim 1 comprising a ready to eat breakfast cereal.

16. A cooked cereal-ingredient containing food product as recited in 1 comprising a toaster pastry.

17. A cooked cereal-ingredient containing food product as recited in claim 1 comprising a snack bar.

18. A method of making a dried storage stable cooked cereal product comprising the steps of:
mixing a cereal dough with a non-ferric EDTA source and an insoluble iron source;
forming the mixed cereal dough into a plurality of dough pieces;
cooking the plurality of dough pieces thereby forming cereal pieces;
drying the cereal pieces to create a dried storage stable cooked cereal product; and
wherein the combination of the non-ferric EDTA source and the insoluble iron source improves the bioavailability of the insoluble iron source.

19. A method as recited in claim 18 wherein said step of mixing the cereal dough with the insoluble iron source includes mixing reduced iron or, iron phosphate, or mixtures thereof with the cereal dough.

20. A method as recited in claim 18 wherein said step of mixing the cereal dough with the non- ferric EDTA source further comprises mixing Na₂EDTA, tri-sodium EDTA, tetra-sodium EDTA, potassium EDTA, calcium EDTA, or mixtures thereof with the cereal dough.

21. A method as recited in claim 19 wherein said step of mixing the non- ferric EDTA source and the reduced iron further comprises by mixing the non-ferric EDTA source and the reduced iron at a molar ratio of at least 1:1.

22. A method as recited in claim 19 wherein said step of mixing the non-ferric EDTA source and the reduced iron further comprises mixing the non-ferric EDTA source and the reduced iron at a molar ratio of about 1:2.4.

23. A method as recited in claim 19 wherein said step of mixing the non-ferric EDTA source and the iron phosphate further comprises mixing the non-ferric EDTA source and the iron phosphate at a molar ratio of at least 1:1.

24. A method as recited in claim 18 wherein said step of mixing the cereal dough further comprises mixing at least one of wheat, rice, oat, corn, barley, rye, millet, sorghum, amarranth seed, or combinations thereof with the cereal dough.

25. A method as recited in claim 18 wherein said step of mixing the cereal dough further comprises mixing at least one of sugars, salts, spices, flavorings, fruits, nuts, vitamins, minerals, or combinations thereof with the cereal dough.

26. A method as recited in claim 18 wherein said step of mixing the cereal dough further comprises mixing psyllium with the cereal dough.

27. A method as recited in claim 18 further including the step of mixing at least one of a source of calcium, magnesium, zinc, copper, selenium, or combinations thereof with the cereal dough.

28. A method as recited in claim 19 wherein said step of mixing a cereal dough with a non-ferric EDTA source and reduced iron further comprises selecting a reduced iron source having less than 5% of its particle sizes being greater than 75 microns.

29. A method as recited in claim 19 wherein said step of mixing a cereal dough with a non-ferric EDTA source and reduced iron further comprises selecting a reduced iron source having at least 95% of its particle sizes being greater than 45 microns.
